(19) United States
(12) Patent Application Publication
(10) Pub. No.: US 2019/0351809 A1
(43) Pub. Date: Nov. 21, 2019

(54) Load Binder with Enclosed Ratchet Mechanism and Foldable Handle

(71) Applicant: Jianmin Liu, Potomac, MD (US)

(72) Inventor: Jianmin Liu, Potomac, MD (US)

(21) Appl. No.: 16/525,356

(22) Filed: Jul. 29, 2019

Related U.S. Application Data
(63) Continuation-in-part of application No. 15/589,848, filed on May 8, 2017, now Pat. No. 10,384,591.
Application No. 15/589,848 is a continuation-in-part of application No. 16/525,322, filed on Jul. 29, 2019.
Application No. 16/525,322 is a continuation-in-part of application No. 15/589,848, filed on May 8, 2017, now Pat. No. 10,384,591.

(51) Int. Cl. B60P 7/08

(52) U.S. Cl. CPC B60P 7/083

(57) ABSTRACT

A load binder with an enclosed ratchet mechanism and a foldable handle consists of an elongated tubular portion, a handle, a ratcheting mechanism, a first threaded shaft, and a second threaded shaft. The first threaded shaft and the second threaded shaft are rotatably engaged to a tubular body of the elongated tubular portion. However, the first threaded shaft and the second threaded shaft do not detach from the tubular body. The tension on a chain that is attached at the first threaded shaft and the second threaded shaft can be adjusted by rotating the tubular body. The ratcheting mechanism is used to control the tubular body about the first threaded shaft and the second threaded shaft. To be protected from dirt and the like, the ratcheting mechanism is enclosed. The handle, which is foldable, is used to control the ratcheting mechanism.

The current application is a continuation-in-part (CIP) application of the U.S. non-provisional application Ser. No. 15/589,848 filed on May 8, 2017.

### FIELD OF THE INVENTION

The present invention relates generally to securing cargo for transport. More specifically, the present invention relates to an improved ratcheting load binder with a foldable handle.

### BACKGROUND OF THE INVENTION

Cargo is goods or merchandise that conveyed in a ship, airplane, or vehicle. Generally, chains and load binders are used to secure cargo prior to being transported. The present invention is related to load binders. More specifically, the present invention addresses drawbacks of existing ratchet load binders.

The ratchet load binder, also referred to as the ratchet binder, is a device that uses a ratcheting action to tension a chain and secure cargo. In doing so, the ratchet load binder utilizes a handle used to control a ratcheting mechanism and two tension hooks on each end. Even though existing ratchet load binders have a series of benefits, there are also certain drawbacks that need to be addressed.

A major issue with existing ratchet load binders is the exposed ratcheting mechanism. Thus, the ratcheting mechanism is in direct contact with dirt, water, and other external material that can harm the overall functionality of the load binder. When exposed over an extended time, the gears and other moving components of the ratcheting mechanism can be damaged. Replacing these damaged components can be financially disadvantageous to the user. Moreover, cleaning dust or snow from the moving parts can be a time-consuming process which is disadvantageous in a commercial environment.

The protruding handle is another issue with existing load binders. The handle not only interferes with securing the chain but also makes the load binder more susceptible to theft. As an example, if a lock is not used, the handle can be used to loosen the tension of the load binder and access any cargo that was secured in place with the load binder. Therefore, a method that can minimize access to the load binder is required.

When securing large loads, the load binder needs to be tightened extensively. As a result, the attachment hooks and related components can be detached from the structural body of the load binder. Detaching of the attachment hooks can result in potential injury to the user. Moreover, detaching of the hooks can also be time consuming since the securing process needs to be repeated.

The objective of the present invention is to address the aforementioned issues. In particular, the present invention introduces a load binder with a ratcheting mechanism which is shielded from the atmosphere. Moreover, the present invention has a foldable handle so that theft and other unfavorable circumstances are prevented. Since the attachment hooks are designed to be locked within a body of the load binder, the present invention also reduces the risk of injury.

### BRIEF DESCRIPTION OF THE DRAWINGS

FIG. 1 is a perspective view of the present invention.

FIG. 2 is a front view of the present invention.

FIG. 3 is an exploded front view of the present invention.

FIG. 4 is a rear view of the present invention.

FIG. 5 is a front view of the tubular body, wherein the first set of internal threads and the second set of internal threads are respectively illustrated in the first opening and the second opening.

FIG. 6 is a side view of the present invention.

FIG. 7 is a cross-sectional view of the ratcheting mechanism, showing the components and their configuration of the ratcheting mechanism.

FIG. 8 is a cross-sectional view of the spring-loaded release mechanism, showing the components and their configuration with respect to the handle and the ratcheting mechanism.

FIG. 9 is a front view of the present invention, wherein the handle is in folded configuration.

### DETAIL DESCRIPTIONS OF THE INVENTION

All illustrations of the drawings are for the purpose of describing selected versions of the present invention and are not intended to limit the scope of the present invention.

The present invention introduces a ratcheting load binder with an enclosed ratcheting mechanism and a foldable handle. By utilizing the present invention, drawbacks related to malfunctioning of the ratcheting mechanism can be avoided. Moreover, convenience and safety is maximized with the introduction of the foldable handle.

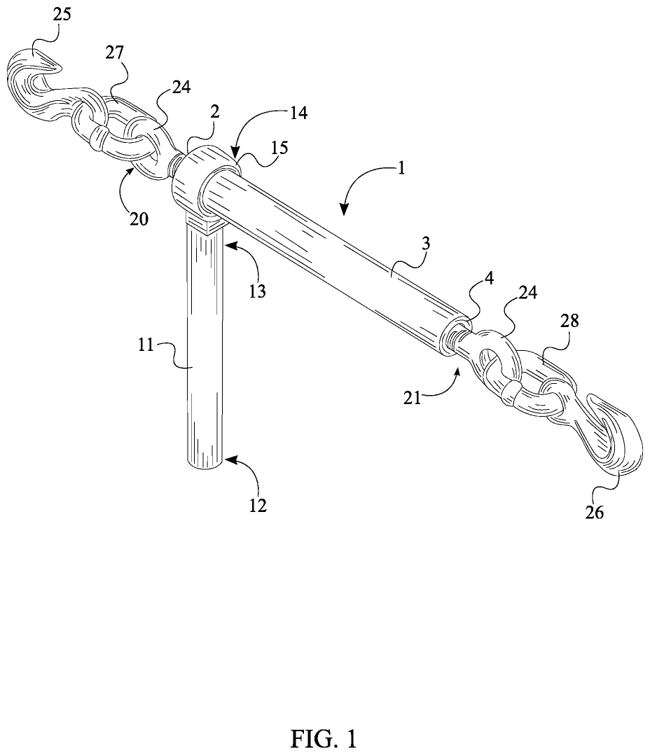

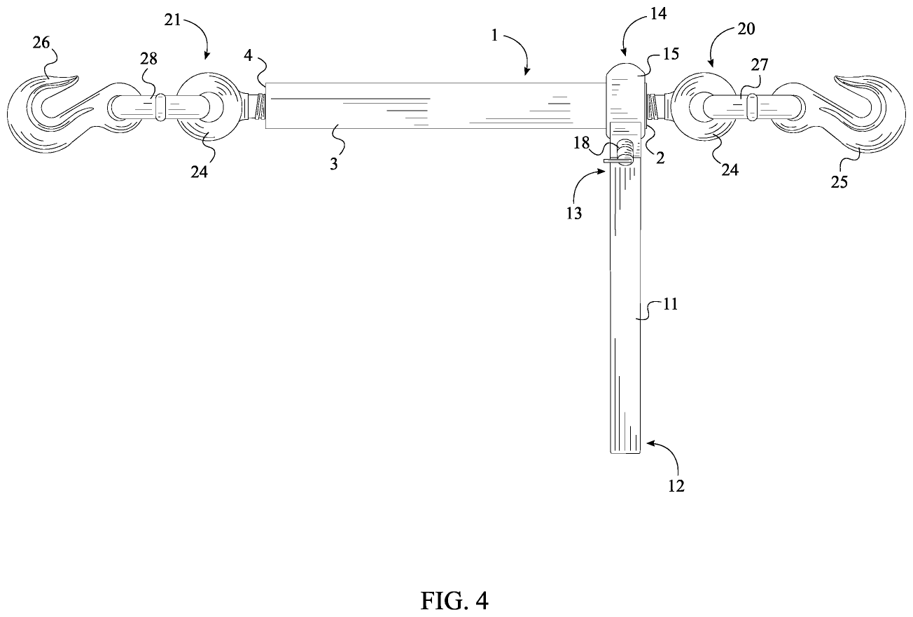

As seen in FIGS. 1-4, the present invention comprises an elongated tubular portion 1, a handle 11, a ratcheting mechanism 14, a first threaded shaft 20, and a second threaded shaft 21. The elongated tubular portion 1, which is the main structural body, can vary in size and shape in different embodiments of the present invention. The handle 11, which is designed to be foldable, is used to control the ratcheting mechanism 14. The size and shape of the handle 11 can also vary from one embodiment to another. As an example, if the user requires significant leverage when controlling the ratcheting mechanism 14, a longer handle 11 can be used within the present invention. The first threaded shaft 20 and the second threaded shaft 21 are used to attach the present invention to a chain that is used to secure cargo. More specifically, when the ratcheting mechanism 14 is controlled with the handle 11, the first threaded shaft 20 and the second threaded shaft 21 adjust the tension on the chain that is used with the present invention to secure cargo. To prevent damage and boost longevity, the ratcheting mechanism 14 of the present invention is configured as an enclosed structure.

The elongated tubular portion 1 provides the structural base of the present invention and comprises a first end 2, a tubular body 3, and a second end 4. The tubular body 3 extends from the first end 2 to the second end 4 and determines the overall length of the elongated tubular portion 1. The tubular body 3 is preferably made of a sturdy material such as steel so that the tubular body 3 can withstand impacts caused by heavy loads used with the present invention. To adjust the tension of a chain attached to the present invention, the first threaded shaft 20 is concentrically and terminally engaged to the tubular body 3 at the first end 2. Similarly, the second threaded shaft 21 is concentrically and terminally engaged to the tubular body 3 at the second end 4. The ratcheting mechanism 14 which controls the position of the tubular body 3 relative to the first threaded shaft 20 and the second threaded shaft 21 is rotatably mounted onto the tubular body 3. In the preferred embodiment of the present invention, the ratcheting mechanism 14 is terminally mounted onto the tubular body 3, wherein the ratcheting mechanism 14 is mounted adjacent to the first end 2 or the second end 3. To accommodate to the shape of the tubular body 3 and be positioned at a preferred position along a perimeter of the tubular body 3, the ratcheting mechanism 14 encircles the tubular body 3. As mentioned before, the ratcheting mechanism 14 is controlled with the handle 11 which is foldably connected onto the ratcheting mechanism 14. Overall, by using the handle 11, the ratcheting mechanism 14 can be controlled. Thereby, the elongated tubular portion 1 can be controlled to adjust the tension at the first threaded shaft 20 and the second threaded shaft 21.

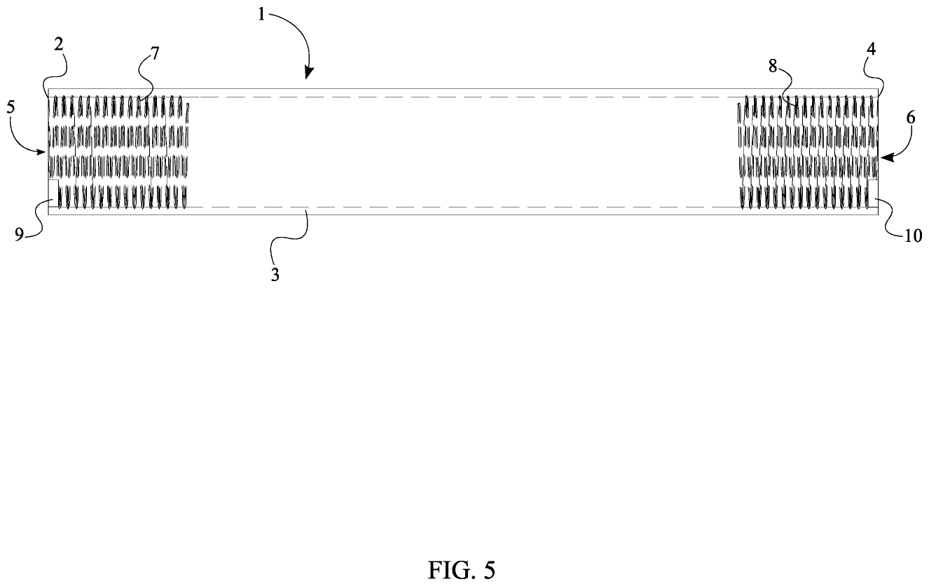

As seen in FIG. 5, for the first threaded shaft 20 and the second threaded shaft 21 to be attached to the tubular body 3, the elongated tubular portion 1 further comprises a first opening 5, a second opening 6, a first set of internal threads 7, and a second set of internal threads 8. The first opening 5 concentrically traverses into the tubular body 3 at the first end 2 and is sufficiently sized to receive the first threaded shaft 20. Likewise, the second opening 6 concentrically traverses into the tubular body 3 at the second end 4 and is sufficiently sized to receive the second threaded shaft 21. To engage with the first threaded shaft 20, the first set of internal threads 7 traverses into the tubular body 3 from the first opening 5 and adjacent to the first end 2. Similarly, to engage with the second threaded shaft 21, the second set of internal threads 8 traverses into the tubular body 3 from the second opening 6 and adjacent to the second end 4. The purpose of the present invention is to apply tension to chains or straps that securing cargo to the bed of a cargo truck or similar applications; thus, in order to accomplish this, the first threaded shaft 20 and the second threaded shaft 21 must move axially in opposing directions. For the first threaded shaft 20 and the second threaded shaft 21 to extend from or retract into the tubular body 3 in opposing directions, and thereby increase the tension or reduce the tension on the attached chain, the first set of internal threads 7 spiral in a first helical direction. On the other hand, the second set of internal threads 8 spiral in a second helical direction which is opposite to the first helical direction. In other words, the first set of internal threads 7 and the second set of internal threads 8 have opposing handedness. When the tubular body 3 is rotated in one direction, the first helical direction and the second helical direction ensure that the first threaded shaft 20 and the second threaded shaft 21 simultaneously move in opposite directions.

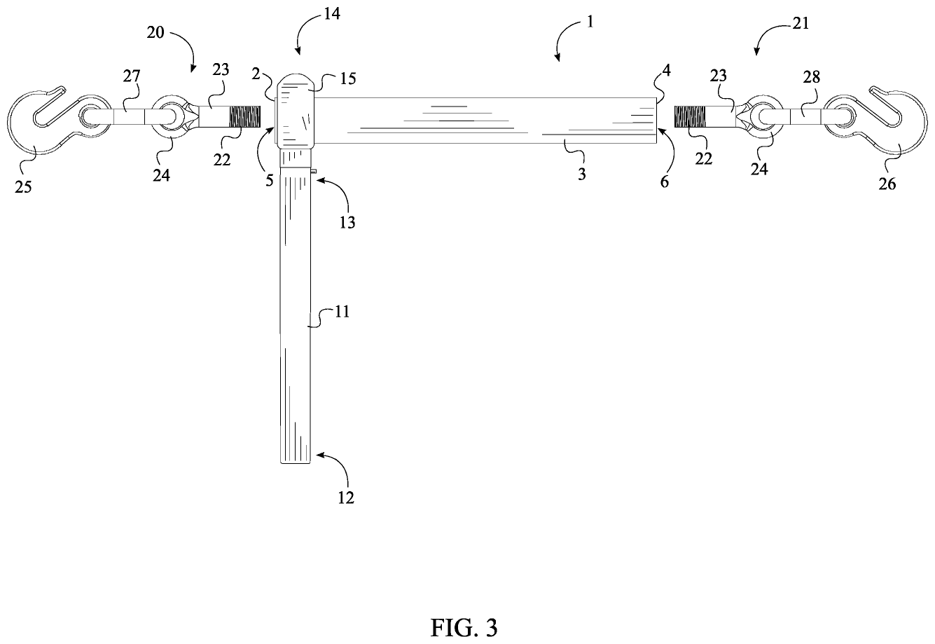

The first threaded shaft 20 and the second threaded shaft 21 need to be designed to correspond with the tubular body 3. As seen in FIG. 3, the first threaded shaft 20 and the second threaded shaft 21 each comprise an externally threaded portion 22, a shaft body 23, and an attaching end 24. The externally threaded portion 22 of the first threaded shaft 20 is used to establish a connection with the first set of internal threads 7. In doing so, the externally threaded portion 22 of the first threaded shaft 20 is rotatably engaged with the first set of internal threads 7. The externally threaded portion 22 of the second threaded shaft 21 is used to establish a connection with the second set of internal threads 8. In doing so, the externally threaded portion 22 of the second threaded shaft 21 is rotatably engaged with the second set of internal threads 8. The shaft body 23, which extends from the externally threaded portion 22 to the attaching end 24, can vary in size and shape in different embodiments of the present invention. The attaching end 24 of both the first threaded shaft 20 and the second threaded shaft 21 is used to establish a connection with the chain that is used to secure cargo.

In existing ratchet load binders, when the tension exceeds a threshold point, the attachment hooks tend to detach from a main body. Such detachments can lead to potential injury. To prevent such circumstances, the elongated tubular portion 1 further comprises a first stop 9 and a second stop 10 as shown in FIG. 5. The first stop 9 is integrated into the first set of internal threads 7 at the first end 2. Therefore, when the first threaded shaft 20 extends outwards from the first end 2, the externally threaded portion 22 of the first threaded shaft 20 does not unthread beyond the first stop 9. Similar to the first stop 9, the second stop 10 is integrated into the second set of internal threads 8 at the second end 4. Therefore, when the second threaded shaft 21 extends outwards from the second end 4, the externally threaded portion 22 of the second threaded shaft 21 does not unthread beyond the second stop 10.

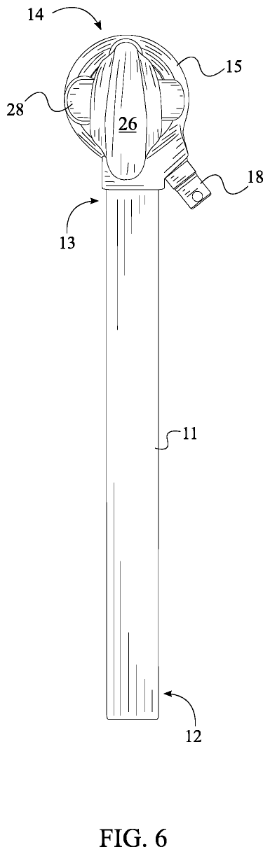

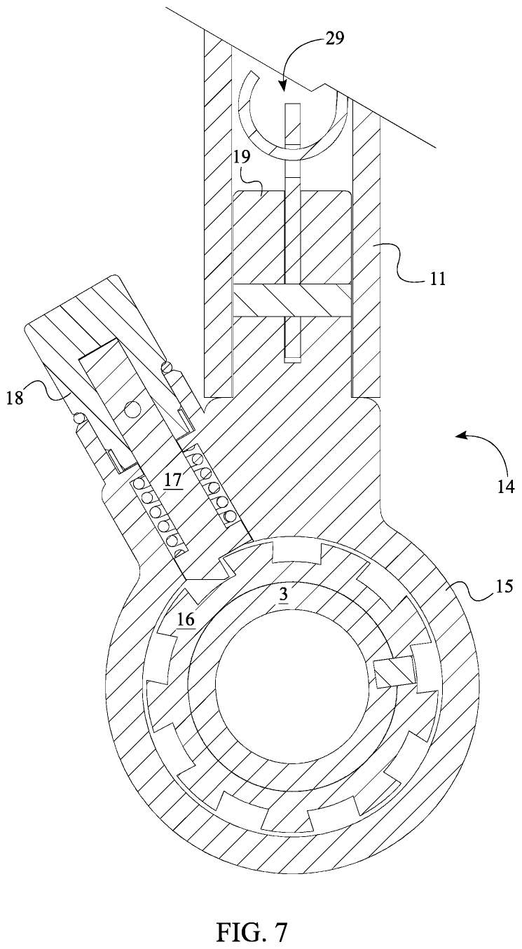

The ratcheting mechanism 14 is used to control the position of the elongated tubular body 3 about the first threaded shaft 20 and the second threaded shaft 21. By doing so, the user can control the overall tension applied on the chain that is being used with the present invention. As discussed earlier, the ratcheting mechanism 14 of the present invention is designed with no exposure to the atmosphere. As illustrated in FIG. 7, the ratcheting mechanism 14 comprises an enclosed housing 15, a ratchet gear 16, a spring loaded pawl 17, a pawl lever 18, and an attachment protrusion 19. The moving components of the ratcheting mechanism 14, which are the ratchet gear 16 and the spring loaded pawl 17, are positioned within the enclosed housing 15. The spring loaded pawl 17, which determines the direction in which the ratchet gear 16 rotates, is mechanically engaged to the ratchet gear 16. Therefore, when the direction of the ratchet gear 16 needs to be adjusted the user controls the spring loaded pawl 17. Since the spring loaded pawl 17 is positioned within the enclosed housing 15, the user needs an extension that can be used to control the spring loaded pawl 17 externally. The pawl lever 18, which is axially connected to the spring loaded pawl 17, functions as a means for engaging and disengaging the spring loaded pawl 17 with the ratchet gear 16. In doing so, the pawl lever 18 extends outwards from the enclosed housing 15 as seen in FIG. 6. The pawl lever 18 extends outward via an opening of the enclosed housing 15 which is delineated by a rubber ring. Therefore, the ratchet gear 16 and the spring loaded pawl 17 remain unexposed. When the spring loaded pawl 17 is set to a preferred direction, the user proceeds to rotate ratcheting mechanism 14 in the preferred direction at the attachment protrusion 19. When reversing the direction of rotation, the user pulls on the pawl lever 18, rotates the pawl lever 18 180-degrees to change the orientation of the spring loaded pawl 17, and releases the pawl lever 18 so that the spring loaded pawl 17 re-engages the ratchet gear 16 in the opposite orientation. To be conveniently accessed and controlled, the attachment protrusion 19 is externally connected onto the enclosed housing 15 as seen in FIG. 7.

The ratcheting mechanism 14 is terminally mounted onto the tubular body 3 through a connector pin so that the ratcheting mechanism 14 is able to fully transfer rotational force to the tubular body 3 with respect to the leverage of the handle 11. More specifically, the connector pin traverses through the tubular body 3 and engages with the ratchet gear 16 from the inside of the tubular body 3. As a result, opposite ends of the connector pin are able to secure the tubular body 3 to the ratcheting mechanism 14. Furthermore, the opposite ends of the connector pin only traverse into a sleeve portion of the ratchet gear 16 and does not extend into a plurality of gears of the ratchet gear 16 so that the spring loaded pawl 17 can freely engage with the plurality of gears of the ratchet gear 16 without any interference from the connector pin.

The handle 11 is used along with the attachment protrusion 19 when rotating the ratcheting mechanism 14 in the preferred direction. To be used in conjunction with the attachment protrusion 19 as seen in FIG. 1-4 and FIG. 7, the handle 11 comprises a free end 12 and a fixed end 13 wherein the free end 12 and the fixed end 13 are oppositely positioned of each other about the handle 11. The fixed end 13 is concentrically connected around the attachment protrusion 19 with a spring-loaded release mechanism 29 so that the ratcheting mechanism 14 can be controlled by grasping the handle 11.

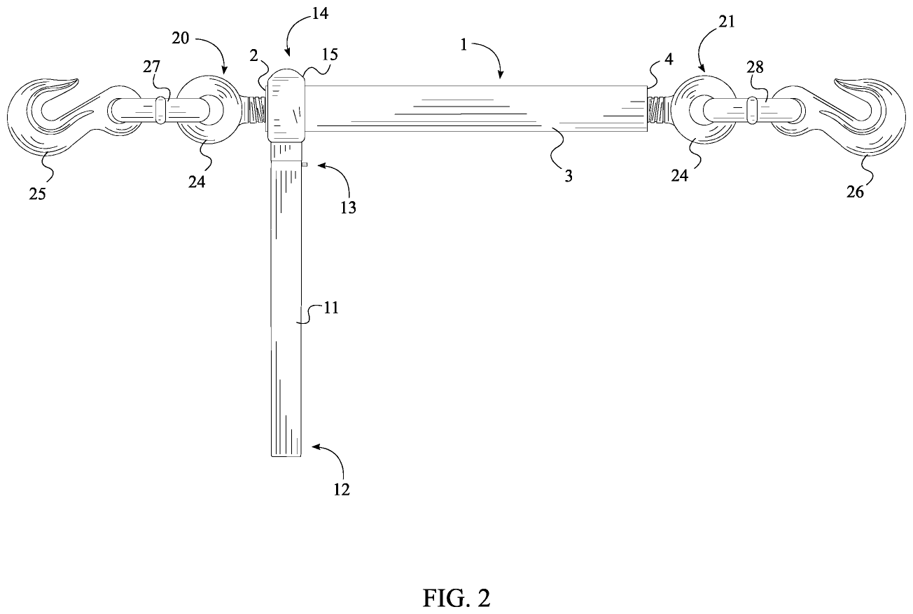

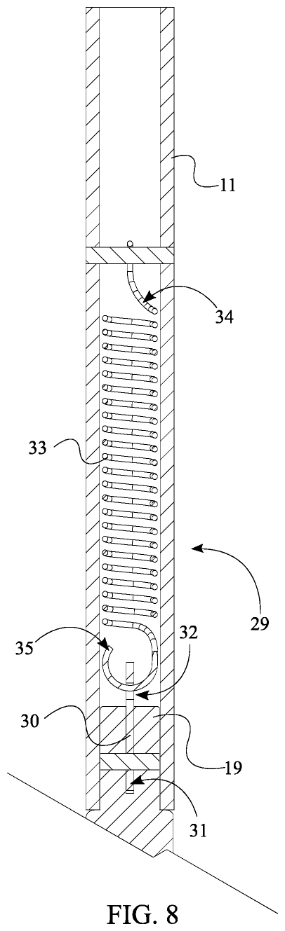

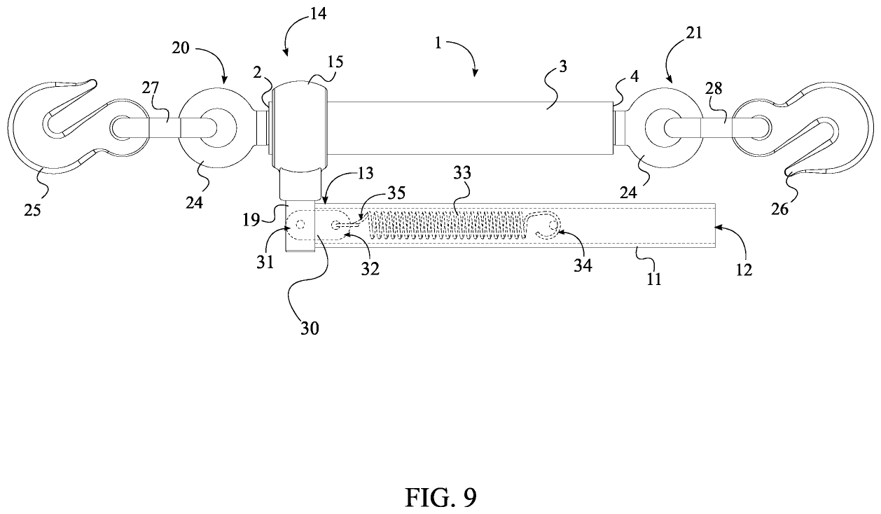

The spring-loaded release mechanism 29 can vary from one embodiment to another. In the preferred embodiment of the present invention, a spring-loaded release mechanism 29 comprises a link 30 and a spring 33 as shown in FIG. 8. More specifically, the spring 33 is concentrically positioned within the handle 11 so that the handle 11 can be pulled toward the attachment protrusion 19. A first end 31 of the link 30 is hingedly connected to the attachment protrusion 19 so that the link 30 can be folded toward the first end 2 of the elongated tubular portion 1 or the second end 4 of the elongated tubular portion 1. A first spring end 34 of the spring 33 is connected within the handle 11 and positioned adjacent to the free end 12 of the handle 11 thus maintaining a fixed position for the spring 33. A second end 32 of the link 30 is connected to a second spring end 35 of the spring 33 so that the spring 33 and the link 30 can be connected to each other within the handle 11. The spring 33 functions as a tension/extension spring so that the handle 11 can be pulled toward the attachment protrusion 19. As shown in FIG. 2, when a load is not applied to the handle 11 the handle 11 is positioned perpendicular to the tubular body 3. As shown in FIG. 9, when the handle 11 needs to be folded, the user can pull the handle 11 away from the tubular body 3 so that the handle 11 can be disengaged from the attachment protrusion 19. Then, the handle 11 is folded toward the first end 2 of the elongated tubular portion 1 or the second end 4 of the elongated tubular portion 1. Once the handle 11 is released, the spring 33 pulls back the handle 11 toward the attachment protrusion 19, wherein the handle 11 is positioned parallel to the tubular body 3.

As mentioned earlier, the handle 11 is used to control the ratcheting mechanism 14 which thereby repositions the elongated tubular portion 1 about the first threaded shaft 20 and the second threaded shaft 21. By doing so, the tension on the chain used with the present invention is adjusted. The present invention comprises a first attachment member 25 and a second attachment member 26 which are used to attach the present invention to the chain. The first attachment member 25 is connected at the attaching end 24 of the first threaded shaft 20. Likewise, the second attachment member 26 is connected to the attaching end 24 of the second threaded shaft 21. The first attachment member 25 and the second attachment member 26 can vary in different embodiments of the present invention. In the preferred embodiment of the present invention both the first attachment member 25 and the second attachment member 26 are attachment hooks. In another embodiment of the present invention, each of the first attachment member 25 and the second attachment member 26 can be, but is not limited to, a U-shaped handle or an attachment ring.

For the first attachment member 25 and the second attachment member 26 to be independent of the first threaded shaft 20 and the second threaded shaft 21 respectively, the present invention further comprises a first intermediary chain link 27 and a second intermediary chain link 28. The first intermediary chain link 27 interconnects the attaching end 24 of the first threaded shaft 20 and the first attachment member 25. More specifically, the first attachment member 25 is connected to the attaching end 24 of the first threaded shaft 20 via the first intermediary chain link 27 as seen in FIGS. 1-4. On the other hand, the second intermediary chain link 28 interconnects the attaching end 24 of the second threaded shaft 21 and the second attachment member 26. More specifically, the second attachment member 26 is connected to the attaching end 24 of the second threaded shaft 21 via the second intermediary chain link 28.

When the present invention is being used, the following process flow is generally followed. Initially, the first attachment member 25 and the second attachment member 26 are hooked onto the chain the present invention is being used with. Next, the ratcheting mechanism 14 is controlled by grasping and applying leverage to the handle 11 that is connected to the attachment protrusion 19. Resultantly, the first threaded shaft 20 and the second threaded shaft 21 pull toward the tubular body thus setting the preferred tension within the chain.

Although the invention has been explained in relation to its preferred embodiment, it is to be understood that many other possible modifications and variations can be made without departing from the spirit and scope of the invention as hereinafter claimed.

What is claimed is:

1. A load binder with an enclosed ratchet mechanism and a foldable handle comprises:
an elongated tubular portion;
a handle;
a ratcheting mechanism;
a first threaded shaft;
a second threaded shaft;
the elongated tubular portion comprises a first end, a tubular body, and a second end;
the tubular body extending from the first end to the second end;
the first threaded shaft being concentrically and terminally engaged to the tubular body at the first end;
the second threaded shaft being concentrically and terminally engaged to the tubular body at the second end;
the ratcheting mechanism being rotatably mounted onto the tubular body, wherein the ratchet mechanism encircles the tubular body; and
the handle being foldably connected onto the ratcheting mechanism, wherein the handle is used to rotate the elongated body by the ratcheting mechanism.

2. The load binder with an enclosed ratchet mechanism and a foldable handle as claimed in claim 1 further comprises:
the elongated tubular portion further comprises a first opening, a second opening, a first set of internal threads, and a second set of internal threads;
the first opening concentrically traversing into the tubular body at the first end;
the second opening concentrically traversing into the tubular body at the second end;
the first set of internal threads traversing into the tubular body from the first opening adjacent to the first end; and
the second set of internal threads traversing into the tubular body from the second opening adjacent to the second end.

3. The load binder with an enclosed ratchet mechanism and a foldable handle as claimed in claim 2 further comprises:
the first set of internal threads spiraling in a first helical direction; and
the second set of internal threads spiraling in a second helical direction, wherein the second helical direction is opposite of the first helical direction.

4. The load binder with an enclosed ratchet mechanism and a foldable handle as claimed in claim 2 further comprises:
the first threaded shaft and the second threaded shaft each comprise an externally threaded portion, a shaft body, and an attaching end;
the shaft body extending from the externally threaded portion to the attaching end;
the externally threaded portion of the first threaded shaft being rotatably engaged with the first set of internal threads; and
the externally threaded portion of the second threaded shaft being rotatably engaged with the second set of internal threads.

5. The load binder with an enclosed ratchet mechanism and a foldable handle as claimed in claim 2 further comprises:
the elongated tubular portion further comprises a first stop and a second stop;
the first stop being integrated into the first set of internal threads at the first end; and
the second stop being integrated into the second set of internal threads at the second end.

6. The load binder with an enclosed ratchet mechanism and a foldable handle as claimed in claim 1 further comprises:
the ratcheting mechanism comprises an enclosed housing, a ratchet gear, a spring loaded pawl, a pawl lever, and an attachment protrusion;
the ratchet gear and the spring loaded pawl being positioned within the enclosed housing;
the spring loaded pawl being mechanically engaged with the ratchet gear;
the pawl lever being axially connected to the spring loaded pawl, wherein the pawl lever is used to engage and disengage the spring loaded pawl with the ratchet gear;
the pawl lever being extended outwards from the enclosed housing through a rubber ring; and
the attachment protrusion being externally connected onto the enclosed housing.

7. The load binder with an enclosed ratchet mechanism and a foldable handle as claimed in claim 1 further comprises:
the handle comprises a free end and a fixed end;
the free end and the fixed end being oppositely positioned of each about the handle; and
the fixed end being concentrically connected around an attachment protrusion of the ratcheting mechanism.

8. The load binder with an enclosed ratchet mechanism and a foldable handle as claimed in claim 7, wherein the fixed end is foldably mounted to the attachment protrusion with a spring-loaded release mechanism.

9. The load binder with an enclosed ratchet mechanism and a foldable handle as claimed in claim 8 further comprises:
the spring-loaded release mechanism comprises a link and a spring;
the spring being concentrically positioned within the handle;
a first end of the link being hingedly connected to the attachment protrusion;
a second end of the link being connected to a second spring end of the spring; and
a first spring end of the spring being connected within the handle.

10. The load binder with an enclosed ratchet mechanism and a foldable handle as claimed in claim 1 further comprises:
a first attachment member;
a second attachment member;
the first attachment member being connected to the first threaded shaft at an attaching end of the first threaded shaft; and
the second attachment member being connected to the second threaded shaft at an attaching end of the second threaded shaft.

11. The load binder with an enclosed ratchet mechanism and a foldable handle as claimed in claim 10 further comprises:
a first intermediary chain link;
a second intermediary chain link;
the first attachment member being connected to the attaching end via the first intermediary chain link; and
the second attachment member being connected to the attaching end via the second intermediary chain link.

12. The load binder with an enclosed ratchet mechanism and a foldable handle as claimed in claim 10, wherein the first attachment member and the second attachment member are attachment hooks.

13. The load binder with an enclosed ratchet mechanism and a foldable handle as claimed in claim 10, wherein the first attachment member and the second attachment member are U-shaped handles.

14. The load binder with an enclosed ratchet mechanism and a foldable handle as claimed in claim 10, wherein the first attachment member and the second attachment member are attachment rings.

15. The load binder with an enclosed ratchet mechanism and a foldable handle as claimed in claim 1, wherein the ratcheting mechanism is mounted adjacent to the second end of the elongated tubular portion.

16. The load binder with an enclosed ratchet mechanism and a foldable handle as claimed in claim 1, wherein the ratcheting mechanism is mounted adjacent to the first end of the elongated tubular portion.
